(19) United States
(12) Patent Application Publication
(10) Pub. No.: US 2009/0009132 A1
(43) Pub. Date: Jan. 8, 2009

(54) Method of powering appliances and apparatus therefor

(76) Inventor: Baruch Richard Dym, Bnei Brak (IL)

Correspondence Address: THE NATH LAW GROUP, 112 South West Street, Alexandria, VA, 22314, US

(21) Appl. No.: 11/822,081

(22) Filed: Jul. 2, 2007

(51) Int. Cl. H02J 7/00

(52) U.S. Cl. 320/127

(57) ABSTRACT

An apparatus for powering appliances includes:

a high powered rechargeable battery;

a battery-operated appliance operated in a portable manner, and connectors for connecting said high powered rechargeable battery to said appliance

The disclosure further includes a method for powering appliances comprising the steps of: using a rechargeable high powered battery to power a battery operated appliance; and connecting said battery to said appliance.

By using the disclosure the appliance becomes portable without the need for conventional electric wiring.

### BACKGROUND OF THE INVENTION

It is the purpose of the present invention to provide a method and an apparatus for powering portable appliance without the need for use of conventional electrical equipment.

For quite a few years there has been a need for portable appliances even where the power level of the appliances is relatively high. Several solutions to this problem exists e.g. using an electric extension cord connecting the appliance to the electric power grid

It is therefore an object of the present invention to provide a new and improved method of and apparatus for powering appliances with substantially overcome the disadvantages of the prior art system described above.

### SUMMARY OF THE INVENTION

The present invention comprises apparatus for powering appliances including:

a high powered rechargeable battery;

a battery-operated appliance operated in a portable manner, and connectors for connecting said high powered rechargeable battery to said appliance.

The present invention further includes a method for powering appliances comprising the steps of: using a rechargeable high powered battery to power a battery operated appliance; and connecting said battery to said appliance.

By using the present invention the appliance becomes portable without the need for conventional electric wiring.

### BRIEF DESCRIPTION OF THE DRAWINGS

Embodiments of the present invention are described by way of example, with reference to the accompanying drawings wherein:

FIG. 1. is a schematic drawing of an appliance in accordance with one embodiment of the invention;

FIG. 2. is a schematic drawing of another appliance in accordance with another embodiment of the present invention;

FIG. 3. is a schematic drawing of the further embodiment of the present invention;

FIG. 4. is a schematic drawing of a still further embodiment of the present invention; and

FIG. 5. is a schematic drawing of an even further embodiment of the present invention.

### DETAILED DESCRIPTION

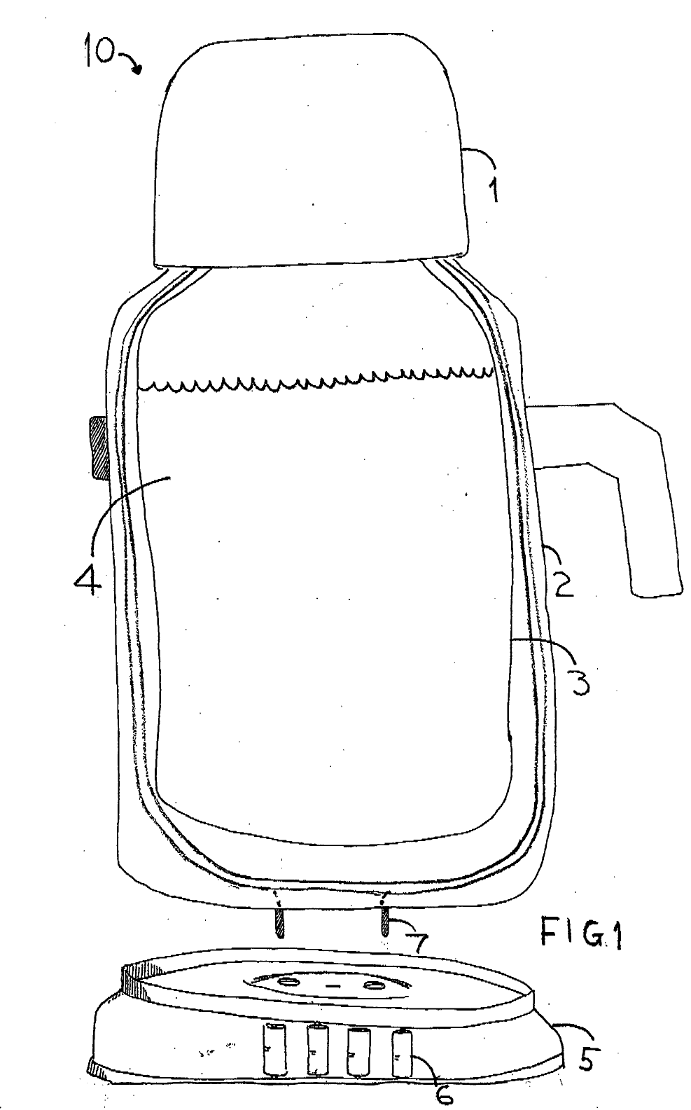

The embodiment described with reference to FIG. 1 designated by reference numeral 10 comprises the following components:

Cap 1 is connected to hot water bottle 2 preferably made of insulating material, e.g. glass, plastic, etc. bottle 2 having high pressure chamber 3 containing liquid 4.

Apparatus 10 also comprises detachable bottom 5 and batteries 6 present preferably in the same container as detachable bottom 5.

Connectors 7 connect the batteries to detachable bottom 5 operated by switch 8.

The embodiment operates in the following manner:

switch 8 activates battery 6 which are connected to a heating element for heating oil in a flexible pipe filled with oil using connectors 7 and heats liquid 4. If preferred an electric heating element present in the bottle can be operated by the battery for directly providing the heat instead of an oil-filled pipe. Once liquid 4 has reached the desired temperature, a thermostat disconnects batteries 6 so that the heated liquid produced can be used for e.g. drinking or other purposes.

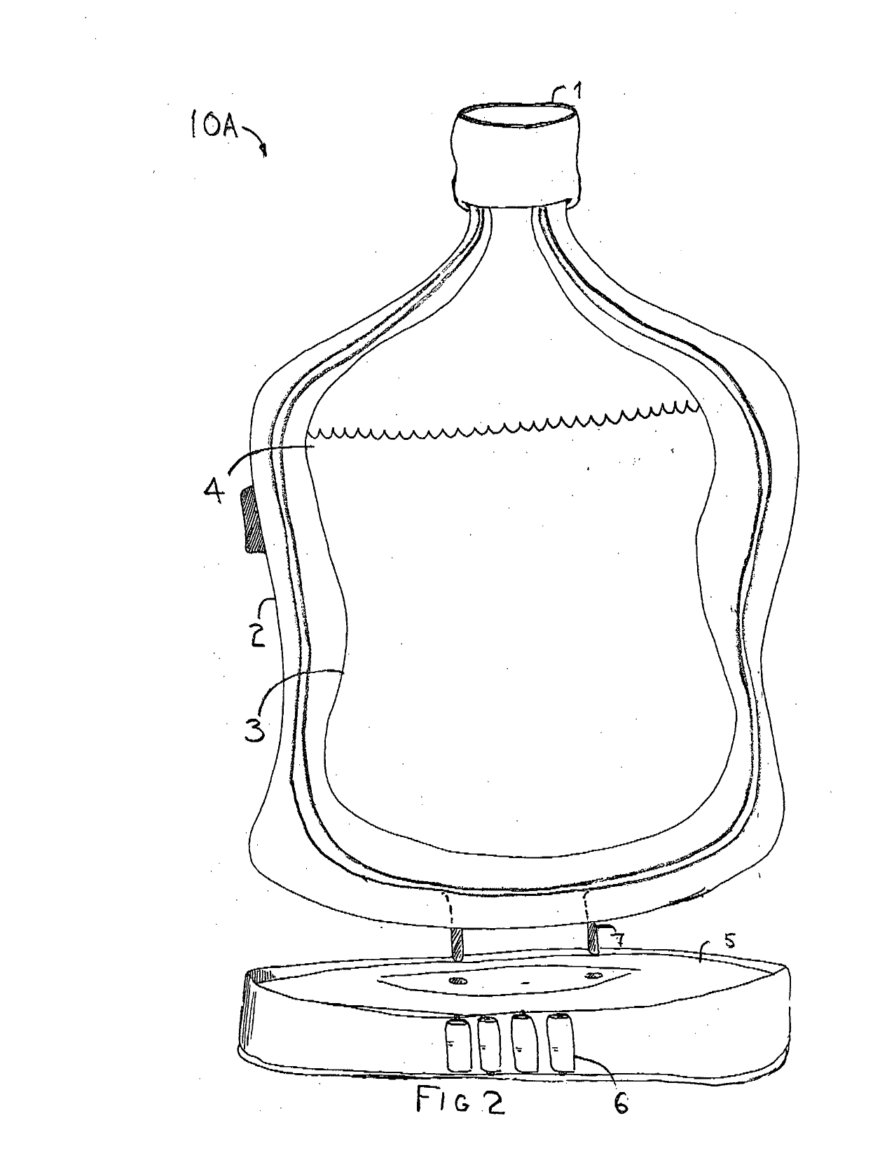

The embodiment described with reference to FIG. 2 designated by reference numeral 10A comprises the following components: Cap 1 is connected to a rubber bottle. The rubber bottle comprises additional rubber bottle 2 and internal bottle 3 which is heated by a heating pipe. Apparatus 10A further comprises of detachable bottom 5, battery 6 and connectors 7 for use in heating of the rubber bottle via switch 8. If preferred an electric heating element present in the bottle can be operated by the battery for providing the heat instead of an oil-filled pipe.

The embodiment described with reference to FIG. 2 operates in the following manner:

Switch 8 activates battery 6 via connector 7 so that flexible insulated pipe 4 (filled with oil) heats liquid present in bottle 2. A thermostat disconnects batteries 6 once the liquid has reached the desired temperature.

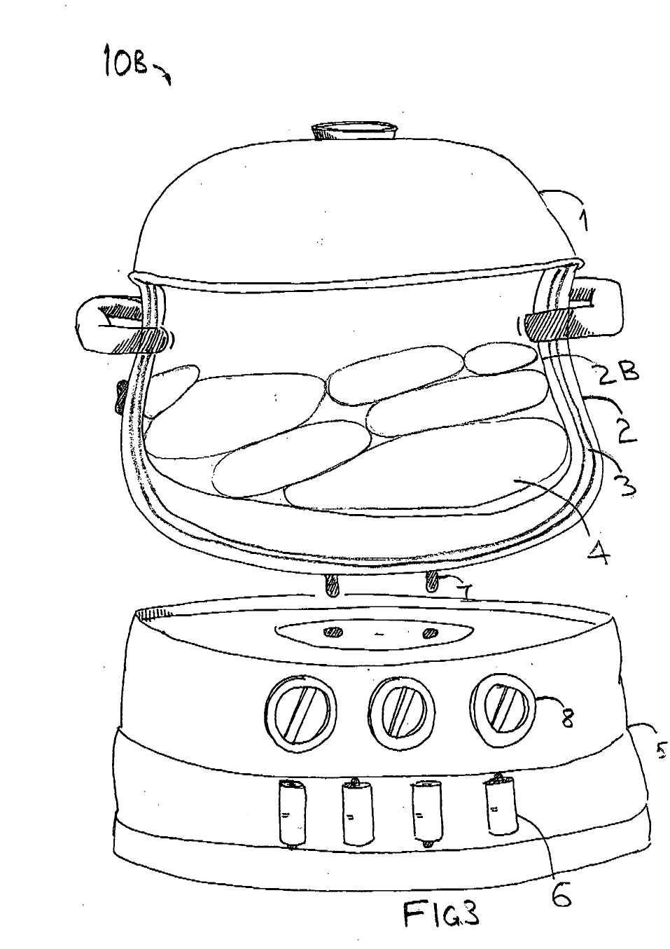

The embodiment described with reference to FIG. 3 designated 10B comprises the following components:

Cover 1 for a cooker, the cooker itself comprises outer cooker 2, chamber (high pressure) 3 and inner cooker 28. Use of batteries 6, connector 7 and a flexible pipe containing oil allows the cooker to be heated by use of switch(es) 8. If preferred, an electric heating element present in the cooker can be operated by the batteries for providing the heat instead of the oil-filled pipe. Preferably, chamber 3 is made of insulating material e.g. glass, plastic, etc.

The embodiment described with reference to FIG. 3 operates as follows:

switch 8 activates rechargeable batteries 6 that is connected via connector 7 to the insulated flexible pipe 1 filled with oil so that the food cooker provides heat to food 4 present in inner cooker 2B.

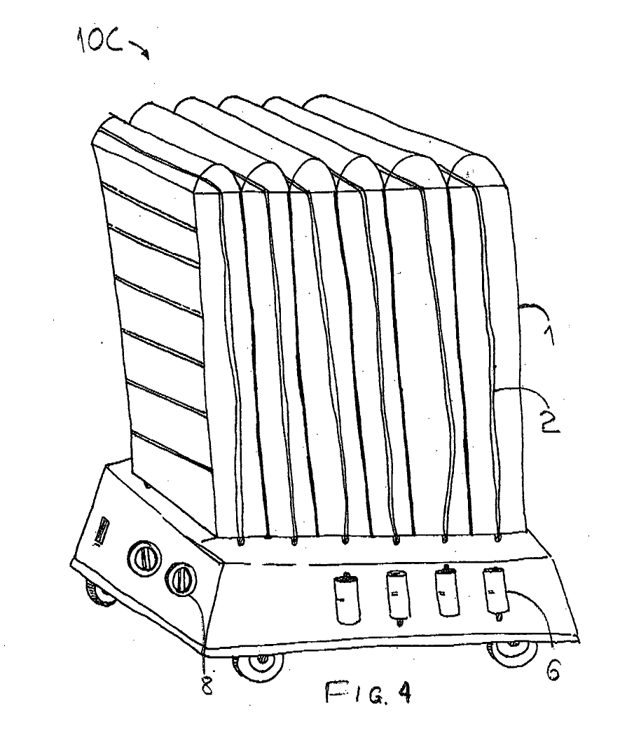

The embodiment described with reference to FIG. 4, designated 10C comprises the following components:

Radiator 1 having insulated flexible pipes 2 filled with oil.

Use of batteries 8 and connectors 7 permit radiator 1 to produce heat by use of switch 8.

This embodiment operates in the following manner:

switch 8 activates batteries 6 connected to oil filled flexible pipes 2 using connector 7 within radiator 1, so that radiator 1 produces heat that supplies heat to, for example, an enclosure.

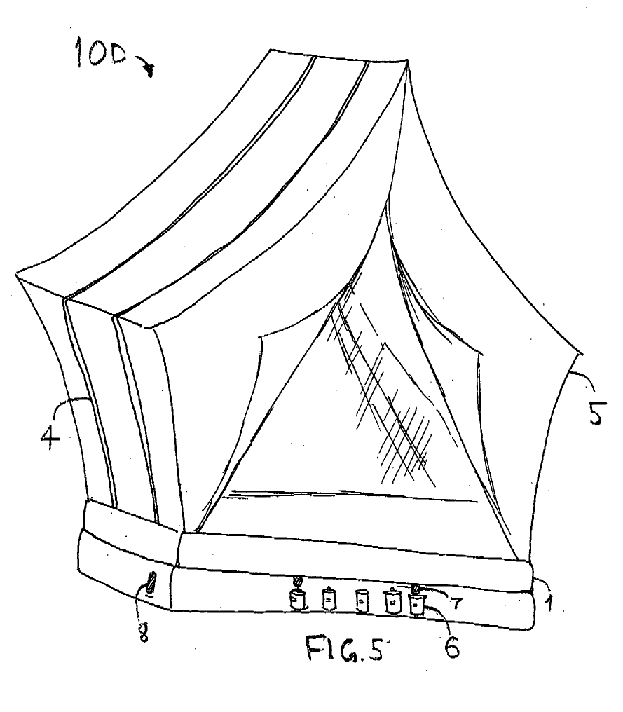

The embodiment described with reference to FIG. 5, designated 10D comprises the following components;

Layer 1 and inside layer 2 in tent 5 having insulated hermetic chamber (airfilled) 3.

Flexible insulated pipes 4 filled with oil 1 heat hermetic chamber and connector 7 connects tent bottom to upper tent and to batteries 6 operated by switch 8.

This embodiment operates as follows:

switch 8 activates batteries 6 connected by connectors 7 to oil-filled flexible pipes 4 that heat internal layers of insulated tent 5 so heat is supplied to the tent.

Non limiting examples for batteries suitable for use in the present invention include: Nickel Metal Hydride (NMH) batteries, nickel cadium batteries, sodium nickel chloride batteries, Lithium-Ion Batteries using, for example, nano-structured battery electrode technology, carbon coated electrode technology, manganese technology, phosphate technology, titanate technology, polymer technology, etc., lithium-thionyl chloride, lithium-sulfur dioxide, lithium manganese dioxide batteries: zinc batteries, lead acid tubular batteries, lead acid batteries having a nano structured carbon battery electrode. Furthermore, an ultra capacitor can be used together with the batteries of the present invention, e.g. lithium-ion battery.

The inventive subject matter being thus described, it will be obvious that the same may be varied in many ways. Such variations are not to be regarded as a departure from the spirit and scope of the inventive subject matter, and all such modifications are intended to be included within the scope of the following claims.

What is claimed is:

1. A method for powering an appliance comprising the steps of:
a) connecting said appliance to a high powered rechargeable battery;
b) using connector to connect said operating appliance to said battery; and operating said appliance using a switch.

2. The method according to claim 1 wherein said method is carried out by connecting a warming bottle to said high powered rechargeable battery.

3. The method according to claim 1 wherein said method is carried out by connecting a bed bottle heater to said high powered rechargeable battery.

4. The method according to claim 1 wherein said method is carried out by connecting a food cooker to said high powered rechargeable battery.

5. The method according to claim 1 wherein said method is carried out by connecting a radiator heater to said high powered rechargeable battery.

6. The method according to claim 1 wherein said method is carried out by connecting a self inflatable heatable tent to said high powered rechargeable battery.

7. Apparatus for powering an appliance comprising:
a) a high powered rechargeable battery;
b) a connector that connects said appliance to said high powered rechargeable battery; and
c) a switch for operating the appliance.

8. Apparatus according to claim 7 wherein said appliance comprises a warming bottle.

9. Apparatus according to claim 7 wherein said appliance comprises a bed bottle heater.

10. Apparatus according to claim 7 wherein said appliance comprises a food cooker.

11. Apparatus according to claim 7 wherein said appliance comprises a radiator.

12. Apparatus according to claim 7 wherein said appliance comprises an inflatable heatable tent.
